(19) United States
(12) Patent Application Publication
(10) Pub. No.: US 2018/0023666 A1
(43) Pub. Date: Jan. 25, 2018

(54) RATCHET CLAMP BLOCK AND METHOD OF USE

(71) Applicants: Don Polak, Nashville, TN (US); Thomas Bush, Canton Center, CT (US)

(72) Inventors: Don Polak, Nashville, TN (US); Thomas Bush, Canton Center, CT (US)

(21) Appl. No.: 15/218,014

(22) Filed: Jul. 23, 2016

(51) Int. Cl. F16G 11/12; B60P 7/08

(52) U.S. Cl. CPC F16G 11/12; B60P 7/083

(57) ABSTRACT

The disclosure of the present invention relates to a clamp block or more specifically to a clamp block having an integrated ratcheting retainer strap mechanism. The ratchet clamp block configured to secure longer stock items and is particularly configured to secure items having a long irregular or cylindrical cross-section.

This application claims priority to U.S. provisional patent application 62/278,931, filed Jan. 14, 2016 with the disclosures therein incorporated by reference.

### SUMMARY OF THE INVENTION

The disclosure of the present invention relates to a clamp block or more specifically to a clamp block having an integrated ratchet strap mechanism. The ratchet clamp block configured to secure longer stock items and is particularly configured to secure items having a cylindrical cross section, such as pressure cylinders including fire extinguishers and oxygen cylinders, long handled tools such as, shovels, rakes or weed trimmers, and sporting goods such as shotguns, rifles, or fishing rod tubes.

One embodiment of the present invention includes a unitized clamp body configured as a channel or C-shape cross section, having a flat bottom and vertical sides. The bottom portion configured having a plurality of mounting holes allowing the body to be securely mounted to a substantially flat surface using bolts, screws or similar fasteners. The vertical sides having an elevated portion configured to receive a ratchet and pawl assembly and a lower saddle portion configured to restrain a round or irregular shaped item placed within the depressed portion of the saddle.

The ratchet and pawl assembly including a main gear, having a slotted shaft portion that extends perpendicular through two axially aligned bearing holes formed in the vertical sides, the first end of the slotted shaft configured be restrained against the outside surface of the vertical wall using a mechanical fastener such as a c-clip or O-ring, the second end of the slotted shaft having a the main gear which is movably restrained against the outside surface of the opposite vertical clamp body wall. The main gear including a plurality of asymmetrical teeth, each of the plurality of teeth having a ramp portion and overhung portion configured to engage a reciprocal pawl tooth. The main gear including a manual turning handle or knob formed on the outside surface of the gear. The pawl assembly also having a shaft which is configured to extend through two perpendicular bearing holes formed in the vertical sides, the pawl shaft having a first end configured to extend through, and be restrained against the outside surface of the vertical body wall, again using a mechanical fastener, such as, a c-clip or O-ring. A pawl gear formed on the second end of the pawl shaft, the pawl gear including one or more teeth configured to ride over the ramp portion of a main gear tooth when the gear is rotated in a first direction and then, the one or more pawl gear teeth will drop into an engagement position with the overhung portion of the main gear tooth and the following main gear tooth to prevent the main gear from moving back in the second or opposite direction. A coil spring configured around the pawl shaft is used to bias the pawl gear into the engagement position. A pawl release lever is formed on the pawl shaft, coplanar with, and extending in a direction opposite from the pawl gear teeth. A retainer strap portion is fixedly attached within the clamp body proximate the saddle end of the body; the free end of the strap is routed under a stationary spindle located within the confines of the vertical wall, proximate the clamp block base on the opposite side of the saddle portion; the free end of the retainer strap then extends from the stationary spindle and through the slot formed in the main gear shaft.

When using the ratcheting clamp block of the present invention and after the clamp block is secured to a rigid surface, the user can place any item desired to be secured under the strap and within the saddle portion of the clamp block base. To secure the item, the user would, manually pull the strap tight, grasp the manual turning knob and rotate the main gear in a clockwise direction, as the main gear is rotated, the retainer strap is wound around main gear shaft, shortening the overall free length of the strap and compressing the item to be secured into the clamp base saddle. Also as the main gear is rotated in a clockwise direction, the pawl gear teeth are progressively riding over the ramp portion of the main gear teeth and engaging with overhung portion of the main gear teeth, restricting the main gear from rotating back in the opposite counter-clockwise direction.

To release the item from the clamp block the user simply moves the release lever to disengage the pawl gear teeth. This allows the main gear to rotate counter-clockwise and unwind the retainer strap from main gear shaft. In situations where the retainer strap is under extreme pressure, it may be necessary for the user to turn the main gear knob clockwise to release pressure on the pawl gear teeth, and allow the pawl release lever to be actuated.

In one embodiment of the present invention the coil pawl tension spring can be replaced with a spring lever formed as a unitized portion of the pawl gear assembly.

In yet another embodiment of the present invention, the main gear knob can be configured to accept a tool such as a wrench, socket or lever bar in order for the user to apply additional force to the main gear and create greater tension within the retainer strap.

In another embodiment the clamp base includes a slotted front spindle that spans between the vertical side portions of the clamp base. The slot formed in the front spindle configured to allow the retainer strap to be extended through the slot and fixed into place. In one embodiment the retainer strap is simply folded over on itself. In another embodiment the retainer strap is fixed in place by sewing the free end back onto running portion of the strap. In another embodiment the retainer strap is fixed in place by sewing a fold in the free end. by melting, gluing or over-molding plastic to create an interference block between the free end of the strap and width of the slot formed in the spindle. In yet another embodiment the free end of the strap is secured with a mechanical fastener such as a screw or bolt.

In another embodiment of the present invention, the bottom of the clamp block base may be concave to conform to a curved surface such a pipe or tubing.

### BRIEF DESCRIPTION OF DRAWINGS

The following description of the embodiments can be understood in light of the Figures which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals or word descriptions in different drawings represent the same element, and thus their descriptions may be omitted.

FIG. 1, a perspective view of the ratchet clamp block assembly,

FIG. 2, a side view of the ratchet clamp block assembly,

FIG. 3, a top view of the ratchet clamp block assembly,

FIG. 4, an end view of the ratchet clamp block assembly,

FIG. 5, a section view of the ratchet clamp block assembly,

FIG. 6, a ratchet clamp block retaining a fire extinguisher, and,

FIG. 7, a ratchet clamp block retaining a shovel.

### DETAILED DESCRIPTION OF DRAWINGS

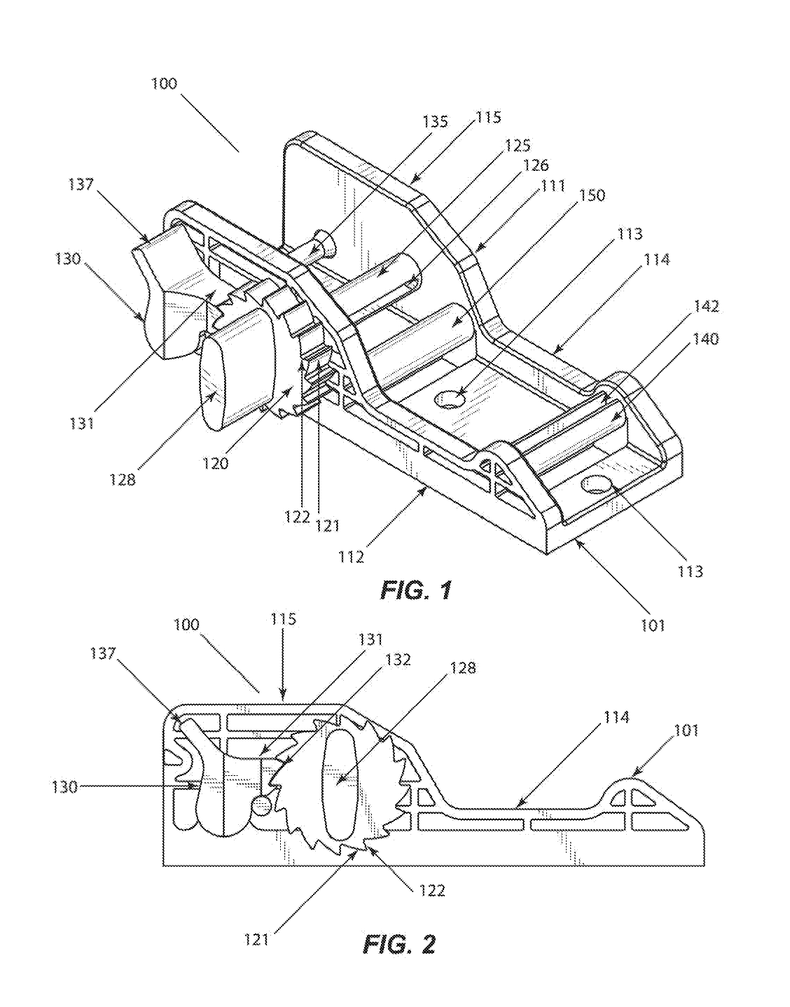

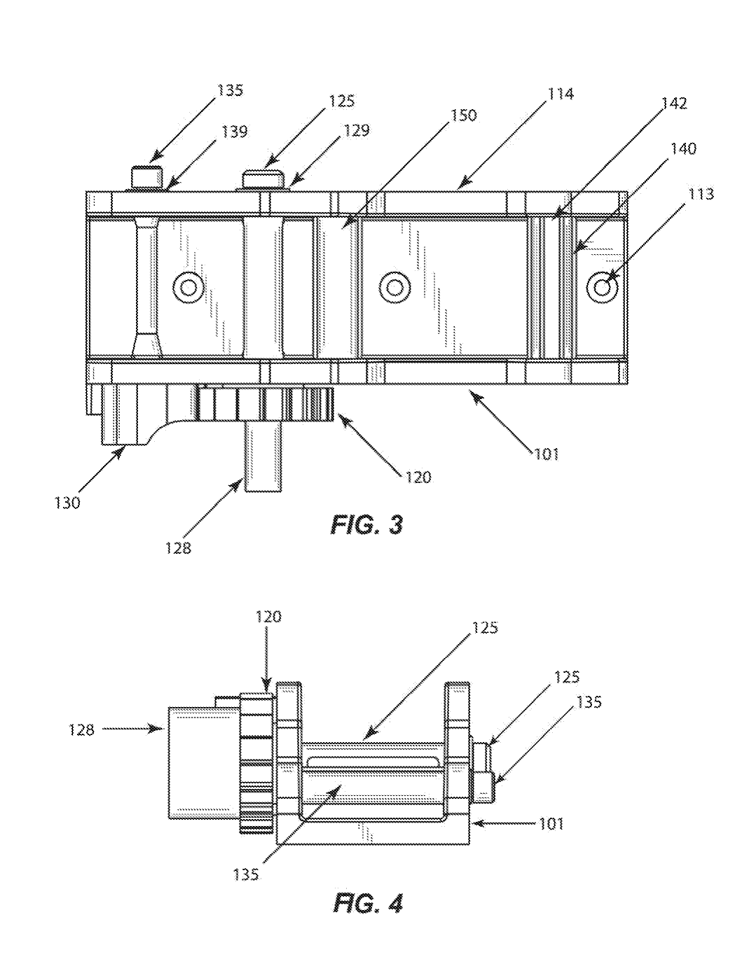

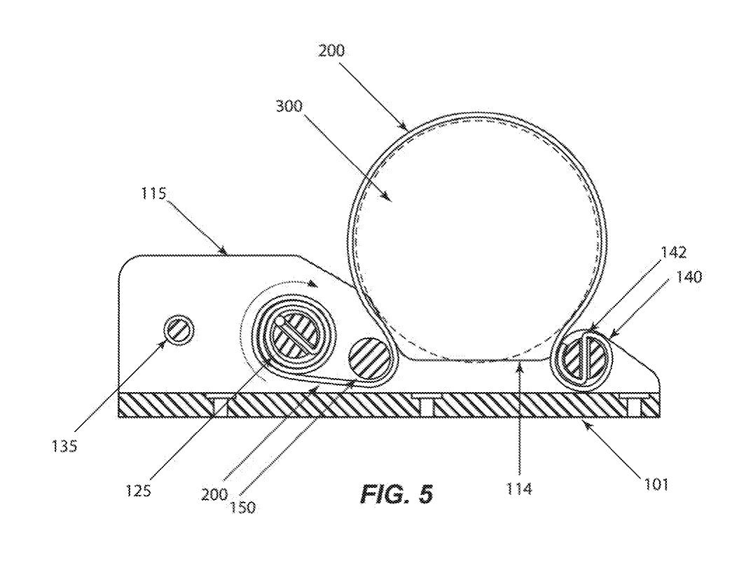

A first embodiment of the present invention or ratchet clamp block assembly 100 is shown in FIGS. 1 through 5, including a main body portion 101 formed as a substantially C-shaped channel having a bottom potion 112 and vertical sides 11, the vertical sides having an elevated portion 115 and a lower portion forming a saddle 114. In one embodiment the bottom portion 112 is substantially flat configured to mounted to a flat surface, in another embodiment the bottom portion 112 has a curved or convex shaped configured to be mounted on curved surface such as a tubular steel roll cage or a vehicle push bar. In each embodiment the bottom portion 112 includes a plurality of mounting holes 113. The elevated portion 115 configured to receive a ratchet and pawl assembly and a lower saddle portion 114 configured to restrain a round or irregular shaped item placed within the depressed portion of the saddle 114.

The ratchet and pawl assembly including a main gear 120 having a shaft 125 that extends perpendicular through two axially aligned bearing holes formed in the vertical sides 111, the first end of the shaft 125 configured be restrained against the outside surface of the vertical wall 111 using a mechanical fastener such as a c-clip or O-ring 129, the second end of the slotted shaft having a the main gear 120 which is movably restrained against the outside surface of the opposite vertical clamp body wall 111. The main gear 120 including a plurality of asymmetrical teeth, each of the plurality of teeth having a ramp portion 121 and overhung portion 122 configured to engage a reciprocal pawl tooth 131. The main gear including a manual turning handle or knob 128 formed on the outside surface of the gear 120. The pawl assembly 130 also having a shaft 135 which is configured to extend through two perpendicular bearing holes formed in the vertical sides 111, the pawl 135 shaft having a first end configured to extend through, and be restrained against the outside surface of the vertical body wall 111, again using a mechanical fastener, such as, a c-clip or O-ring. A pawl gear 131 formed on the second end of the pawl shaft 135, the pawl gear including one or more teeth 131 configured to ride over the ramp portion 121 of a main gear tooth when the gear is rotated in a first direction and then, the one or more pawl gear teeth 131 will drop into an engagement position with the overhung portion 122 of the main gear tooth and the following main gear tooth to prevent the main gear 120 from moving back in the second or opposite direction. A coil spring (not shown) configured around the pawl shaft 135 is used to bias the pawl gear 130 into the engagement position. A pawl release lever 137 is formed on the pawl shaft 135, coplanar with, and extending in a direction opposite from the pawl gear teeth 131. A retainer strap 200 is fixedly attached within the clamp body 101 proximate the saddle 114 end of the body. In one embodiment, the free end of the strap 200 is routed under a stationary spindle 150 located within the confines of the vertical walls 111, proximate the clamp block base on the side of saddle portion 114 proximate the main gear shaft 125; the free end of the retainer strap 200 then extends from the stationary spindle 150 and through a slot 126 formed in the main gear shaft 125. The clamp base 101 may include a strap retention spindle 140 that extends between the vertical walls 111 and the spindle having a slot 142 configured to receive the retainer strap 200.

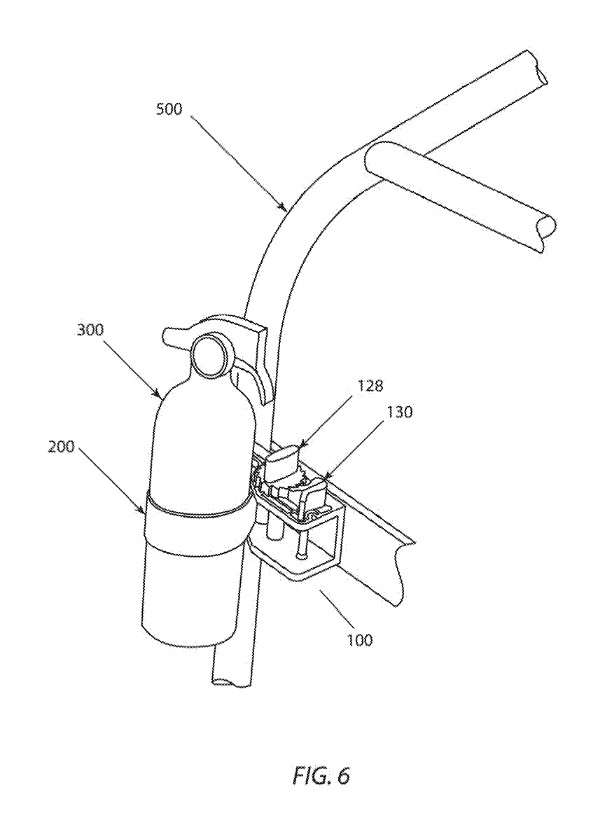

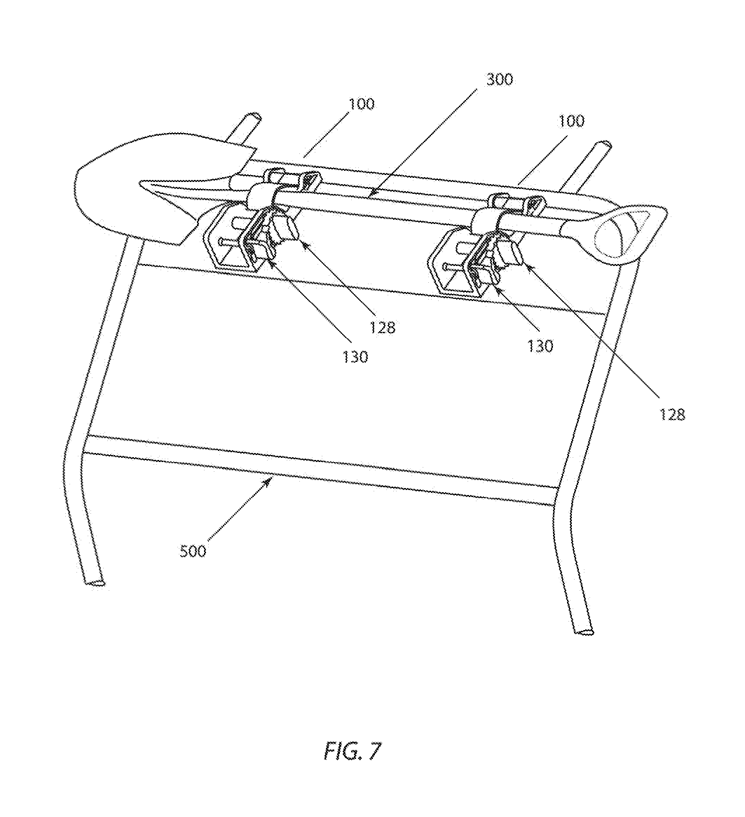

Each of FIGS. 6 and 7 show a first embodiment of the present invention or ratchet clamp block assembly 100 attached to the roll cage 500 of a vehicle such as a, side-by-side, truck, sport utility vehicle, or Jeep®. The ratchet clamp block 100 including retainer strap 200 extending around an object 300, the object such as a fire extinguisher or shovel and the retainer strap 200 securely tightened using the main gear handle 128 of the ratchet and pawl assembly including a main gear 120 and pawl assembly 130.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A ratchet clamp block assembly comprising;
a clamp body,
the clamp body having a first portion and a second portion,
the second portion formed as a saddle,
the saddle having a first end and a second end,
a ratchet gear and pawl assembly formed at the first portion of the clamp body,
the pawl assembly configured to allow the ratchet gear to move in only a first direction,
the ratchet gear attached to a shaft,
a retainer strap,
the retainer strap having a first end and a second end,
the first end of the retainer strap fixedly attached to the second portion of the frame body proximate the second end of the saddle,
the second end of the retainer strap extending over the saddle and engaged with the ratchet gear shaft, and,
when the ratchet gear is moved is the first direction the retainer strap is tensioned over the saddle.

2. The ratchet clamp block assembly of claim 1 wherein the pawl assembly is releasable to allow the ratchet gear to move in a second direction.

3. The ratchet clamp block assembly of claim 1 wherein the ratchet gear includes a tightening mechanism.

4. The ratchet clamp block assembly of claim 3 wherein the tightening mechanism is a hand knob.

5. The ratchet clamp block assembly of claim 3 wherein the tightening mechanism is configured to use one of a tool and a lever.

6. The ratchet clamp block assembly of claim 1 wherein the pawl assembly includes a spring to bias the pawl into an engaged position with the ratchet gear.

7. The ratchet clamp block assembly of claim 1 wherein the pawl assembly includes a release lever.

8. The ratchet clamp block assembly of claim 1 including;
a stationary spindle formed in the first portion of the clamp body proximate the first end of the saddle, and,
the second end of the retainer strap extending under the stationary spindle.

9. The ratchet clamp block assembly of claim 1 wherein;
the shaft attached to the ratchet gear has a slot, and,
the second end of the retainer strap extending through the slot.

10. The ratchet clamp block assembly of claim 1 including a strap retention spindle formed in the clamp body proximate the second end of the saddle.

11. The ratchet clamp block assembly of claim 10 wherein the strap retention spindle includes a slot configured to receive the first end of the retainer strap.

12. The ratchet clamp block assembly of claim 11 wherein the first end of the retainer strap is secured to the retention spindle by one of sewn in a loop, glued, melted, mechanically attached and a plastic over-mold.

13. A method of using a ratchet clamp block assembly comprising;
providing a clamp body,
the clamp body having a first portion and a second portion,
the second portion formed as a saddle,
the saddle having a first end and a second end,
a ratchet gear and pawl assembly formed at the first portion of the clamp body,
the pawl assembly configured to allow the ratchet gear to move in only a first direction,
the ratchet gear attached to a shaft,
a retainer strap,
the retainer strap having a first end and a second end,
the first end of the retainer strap fixedly attached to the second portion of the frame body proximate the second end of the saddle,
the second end of the retainer strap extending over the saddle and engaged with the ratchet gear shaft,
extending an object under the retainer strap and into the saddle, and,
moving the ratchet gear in the first direction to tension the retainer strap over the object.

14. The method of using a ratchet clamp block assembly of claim 13 including releasing the pawl assembly.
